(19) United States
(12) Patent Application Publication
(10) Pub. No.: US 2026/0238093 A1
(43) Pub. Date: Aug. 13, 2026

(54) ELECTRIC COMPRESSOR

(71) Applicants: Hanon Systems, Daejeon (KR); DAEYOUNG ELECTRONICS CO.,LTD, Gyeongsangbuk-do (KR)

(72) Inventors: Hyun Woo Lee, Daejeon (KR); Sung Taeg Oh, Daejeon (KR); Min Gyu Kim, Daejeon (KR); Seung Kil Kim, Daejeon (KR); Sang Woo Bae, Daejeon (KR); Hew Nam Ahn, Daejeon (KR); Young Seop Yoon, Daejeon (KR); Je Su Yun, Daejeon (KR); Nam Ju Kim, Daegu (KR); Ho Kyoon Jang, Gyeonggi-do (KR); Do Won Lim, Daegu (KR)

(21) Appl. No.: 19/160,351

(22) PCT Filed: Jan. 29, 2024
(86) PCT No.: PCT/KR2024/001312

§ 371 Date: Aug. 27, 2025

(30) Foreign Application Priority Data
Apr. 18, 2023 (KR) 10-2023-0050845

(51) Int. Cl. H02K 11/33; H02K 21/14

(52) U.S. Cl. CPC H02K 11/33; H02K 21/14; F25B 2600/021; H02K 2211/03

(57) ABSTRACT

An electric compressor, including: a motor configured to generate power; a compression mechanism driven by the motor and configured to compress a refrigerant; an inverter configured to control the motor; and a plurality of pins configured to electrically connect the motor and the inverter, and the inverter may include a printed circuit board (PCB) on which a switching element is mounted, the printed circuit board (PCB) may include a plurality of pin holes into which the plurality of pins is inserted, the switching element may be formed to be an intelligent power module (IPM) having a plurality of motor connecting terminals, which are connected to the plurality of pine holes, respectively, and the IPM may be disposed such that the plurality of motor connecting terminals is disposed toward the plurality of pin holes.

### CROSS REFERENCE TO RELATED PATENT APPLICATIONS

This is a U.S. national phase patent application of PCT/KR 2024/001312 filed Jan. 29, 2024, which claims the benefit of and priority to Korean Patent Application No. 10-2023-0050845, filed on Apr. 18, 2023, the entire contents of each of which are incorporated herein by reference for all purposes.

### TECHNICAL FIELD

The present disclosure relates to an electric compressor, more particularly, to an electric compressor configured to compress a refrigerant with a driving force of a motor which is controlled by an inverter.

### BACKGROUND ART

Generally, a compressor is an apparatus compressing a fluid such as a refrigerant gas and the like, and is applied to an air conditioning (A/C) system of a building, a vehicle and the like.

The compressor is classified into a reciprocating compressor that compresses a refrigerant according to which pistons reciprocate, and a rotary compressor that compresses a refrigerant while rotating. The reciprocating compressor includes a crank compressor that transmits a driving force from a drive source to a plurality of pistons using a crank, a swash plate compressor that transmits a driving force to a shaft installed with a swash plate, and the like, according to the power transmission from the drive source. The rotary compressor includes a vane rotary compressor that utilizes a rotating rotary shaft and a vane, and a scroll compressor that utilizes an orbiting scroll and a fixed scroll.

In addition, depending on a driving method, the compressors may be classified into a mechanical compressor that uses an engine and an electric compressor that uses a motor (hereinafter, referred to as an electric compressor), and an inverter configured to control the motor for regulating a compression capacity is applied in the electric compressor.

In particular, the conventional electric compressor includes a motor configured to generate power; a compression mechanism driven by the motor and configured to compress a refrigerant; an inverter configured to control the motor; and a plurality of pins configured to electrically connect the motor and the inverter.

In addition, as illustrated in FIG. 1 which is a cross-sectional view showing the printed circuit board 51 of the conventional electric compressor, the inverter includes a printed circuit board (PCB) 51 on which a switching element is mounted, the printed circuit board (PCB) 51 includes a plurality of pin holes (not illustrated) into which the plurality of pins 62 is inserted, and the switching element is formed to be an Insulated Gate Bipolar Transistor (IGBT) 52 having a plurality of motor connecting terminals 52a, which are connected to the plurality of pine holes (not illustrated), respectively.

Here, because a connection distance between the plurality of pin holes (not illustrated) and the motor connecting terminals 52a of the IGBT 52 is very long, a bus bar 53 mounted on the PCB 51 is provided so that the plurality of pin holes (not illustrated) and the motor connecting terminals 52a are connected without dielectric breakdown.

However, in the conventional electric compressor, there is a big problem in that the switching element occupies a great space because the switching element is formed to be the plurality of IGBTs 52 occupying relatively a great volume.

In addition, because the bus bar is used, there is a problem in that a quantity of parts, a weight, and a cost increase.

### SUMMARY

Therefore, an object of the present disclosure is to provide an electric compressor capable of reducing a space occupied by the switching element in the PCB.

In addition, another object of the present disclosure is to provide an electric compressor capable of constraining the increase of the quantity of parts, the weight, and the cost.

One embodiment is an electric compressor, including: a motor configured to generate power; a compression mechanism driven by the motor and configured to compress a refrigerant; an inverter configured to control the motor; and a plurality of pins configured to electrically connect the motor and the inverter, and the inverter may include a printed circuit board (PCB) on which a switching element is mounted, the printed circuit board (PCB) may include a plurality of pin holes into which the plurality of pins is inserted, the switching element may be formed to be an intelligent power module (IPM) having a plurality of motor connecting terminals, which are connected to the plurality of pine holes, respectively, and the IPM may be disposed such that the plurality of motor connecting terminals is disposed toward the plurality of pin holes.

The IPM may be disposed such that the plurality of motor connecting terminals is disposed along a direction parallel to a direction in which the plurality of pin holes is disposed.

The IPM may be disposed such that the plurality of motor connecting terminals is disposed along a direction forming an angle equal to or smaller than 15 degrees with a direction parallel to a direction in which the plurality of pin holes is disposed.

The IPM may be disposed such that at least one among the plurality of motor connecting terminals is disposed to be opposed to the pin hole in a direction perpendicular to a direction in which the plurality of pin holes is disposed.

The IPM may be disposed such that a maximum spacing distance between the plurality of motor connecting terminals and the plurality of pin holes is equal to or smaller than 20 mm.

When a voltage applied to the inverter is 800V or more, the IPM may be disposed such that a minimum spacing distance between the plurality of motor connecting terminals and the plurality of pin holes is equal to or more than 4 mm.

When a voltage applied to the inverter is less than 800V, the IPM may be disposed such that a minimum spacing distance between the plurality of motor connecting terminals and the plurality of pin holes is more than 0 mm and smaller than 4 mm.

The PCB may further include a motor connecting pattern electrically connecting the plurality of pin holes and the plurality of motor connecting terminals.

The inverter may further include a processor mounted on the PCB, the IPM may further include a pulse width modulation (PWM) terminal electrically connected to the processor, the PCB may further include a pulse width modulation pattern electrically connecting the pulse width modulation terminal and the processor, and the processor, the pulse width modulation terminal, and the pulse width modulation pattern may be disposed on an opposite side of the motor connecting pattern based on the IPM.

The inverter may further include a shunt resistance mounted on the PCB, the IPM may further include a sensing terminal electrically connected to the shunt resistance, the PCB may further include a sensing pattern electrically connecting the shunt resistance to the sensing terminal and the processor, and the sensing terminal may be disposed to be spaced apart from the plurality of motor connecting terminals on an axis of a direction in which the plurality of motor connecting terminals is disposed, and the shunt resistance, the processor, and the sensing pattern may be disposed on an opposite side of the motor connecting pattern based on the axis.

The IPM may further include a power terminal, the PCB may further include a high voltage input unit to which a high voltage is applied and a high voltage pattern configured to electrically connect the high voltage input unit to the power terminal, and on the axis, the power terminal may be disposed on an opposite side of the sensing terminal based on the plurality of motor connecting terminals, and the high voltage input unit and the high voltage pattern may be disposed on an opposite side of the sensing pattern based on the power terminal.

The motor connecting pattern, the pulse width modulation pattern, the sensing pattern, and the high voltage pattern may not intersect each other.

The IPM may include a power terminal, the PCB may further include a high voltage input unit to which a high voltage is applied and a high voltage pattern configured to electrically connect the high voltage input unit to the power terminal, and the high voltage input unit may be disposed on a side of the plurality of pin holes, the power terminal may be disposed on the high voltage input unit side based on the plurality of motor connecting terminals, and the high voltage pattern may be disposed on the high voltage input unit and the power terminal side based on the motor connecting pattern.

Another embodiment is an electric compressor, including: a motor configured to generate power; a compression mechanism driven by the motor and configured to compress a refrigerant; an inverter configured to control the motor; and a plurality of pins configured to electrically connect the motor and the inverter, and the inverter may include a printed circuit board (PCB) on which a switching element is mounted, the switching element may be formed to be an intelligent power module (IPM) having a plurality of motor connecting terminals, and the PCB may include a plurality of pin holes into which the plurality of pins is inserted, and a motor connecting pattern electrically connecting the plurality of pin holes and the plurality of motor connecting terminals.

An electric compressor according to the present disclosure includes: a motor configured to generate power; a compression mechanism driven by the motor and configured to compress a refrigerant; an inverter configured to control the motor; and a plurality of pins configured to electrically connect the motor and the inverter, the inverter includes a printed circuit board (PCB) on which a switching element is mounted, the printed circuit board (PCB) includes a plurality of pin holes into which the plurality of pins is inserted, and the switching element is formed to be an intelligent power module (IPM) having a plurality of motor connecting terminals, which are connected to the plurality of pine holes, respectively, thereby a space occupied by the switching element in the PCB can be reduced.

In addition, the IPM is disposed such that the plurality of motor connecting terminals is disposed toward the plurality of pin holes, and the plurality of pin holes and the plurality of motor connecting terminals are electrically connected by a motor connecting pattern of the PCB, thereby the increase of the quantity of parts, the weight, and the cost can be constrained.

### DESCRIPTION OF DRAWINGS

FIG. 1 is a cross-sectional view illustrating a printed circuit board of the conventional electric compressor,

FIG. 2 is a cross-sectional view illustrating an electric compressor according to an embodiment of the present disclosure,

FIG. 3 is a front view illustrating a printed circuit board of the electric compressor in FIG. 2,

FIG. 4 is an enlarged view of A portion in FIG. 3,

FIG. 5 is a front view illustrating a printed circuit board of an electric compressor according to another embodiment of the present disclosure,

FIG. 6 is a front view illustrating a printed circuit board of an electric compressor according to still another embodiment of the present disclosure,

FIG. 7 is a front view illustrating a printed circuit board of an electric compressor according to still another embodiment of the present disclosure, and

FIG. 8 is a rear view of FIG. 7.

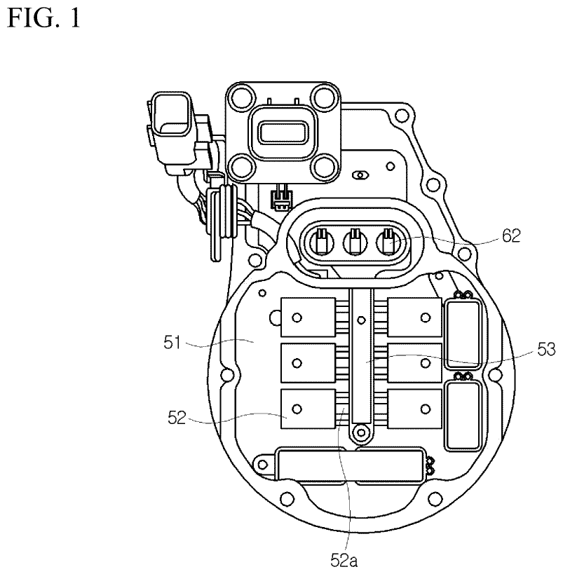

### DESCRIPTION OF AN EMBODIMENT

Hereinafter, an electric compressor according to the present disclosure will be described in detail with reference to the accompanying drawings.

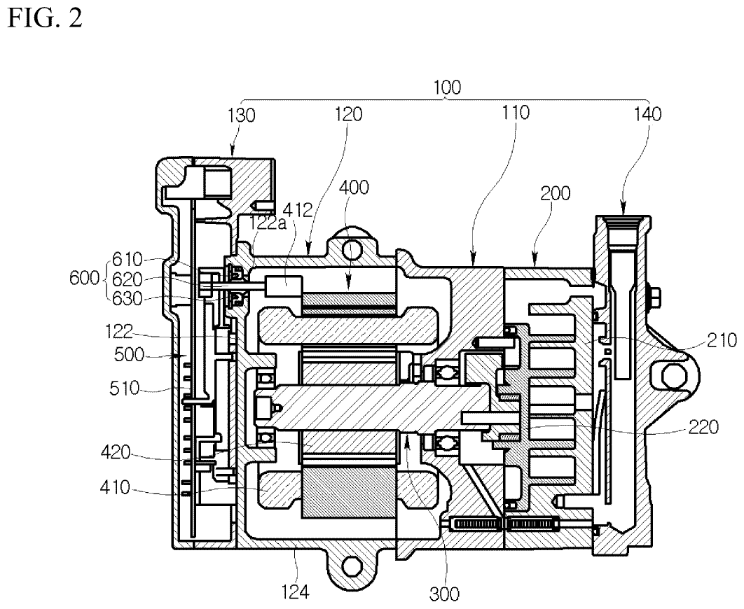

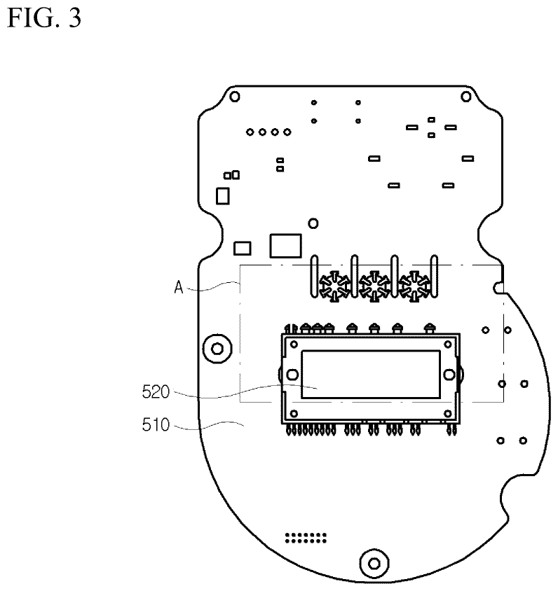

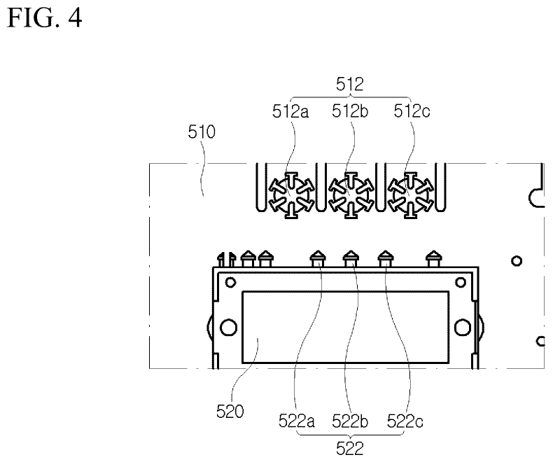

FIG. 2 is a cross-sectional view illustrating an electric compressor according to an embodiment of the present disclosure, FIG. 3 is a front view illustrating a printed circuit board of the electric compressor in FIG. 2, and FIG. 4 is an enlarged view of A portion in FIG. 3.

Referring to FIGS. 2 to 4, an electric compressor according to the present disclosure includes: a housing 100, a compression mechanism 200 configured to compress a refrigerant inside the housing 100; a motor 400 configured to supply power to the compression mechanism 200; an inverter 500 configured to control the motor 400; and a connector 600 configured to electrically connect the motor 400 and the inverter 500.

The housing 100 includes a center housing 110 fastened to one side of the compression mechanism 200, a front housing 120 coupled to the center housing 110 and forming a motor accommodating space in which the motor 400 is accommodated, an inverter housing 130 coupled to the front housing 120 on an opposite side of the center housing 110 based on the front housing 120 and forming an inverter accommodating space in which the inverter 500 is accommodated, and a rear housing 140 coupled to the other side of the compression mechanism 200 and having a discharge chamber accommodating a refrigerant discharged from the compression mechanism 200.

Here, the front housing 120 includes a partition wall 122 partitioning the motor accommodating space and the inverter accommodating space, the partition wall 122 includes a through hole 122a passing through the partition wall 122, and a connector 600 may be mounted on the through hole 122a.

In addition, the front housing 120 further includes an annular wall 124 protruding toward the center housing 110 from an outer periphery of the partition wall 122, and the annular wall 124 may include a suction port (not illustrated) passing through the annular wall 124 through which a refrigerant is guided into the motor accommodating space.

The motor 400 includes a stator 410 supported by the annular wall 124 and a rotor 420 positioned inside the stator to be rotated by an interaction with the stator 410.

The stator 410 includes a multi-laminated iron core having approximately an annular shape, and a coil wound on the iron core, and the coil may be electrically connected to the connector 600 through a motor terminal 412 bound to an end of the coil.

The rotor 420 has an approximately cylindrical shape, includes a permanent magnet, and may be provided such that an outer circumferential surface of the rotor 420 faces an inner circumferential surface of the stator 410 with a predetermined gap. In addition, a rotary shaft 300 that transmits a rotational force of the rotor 420 to the compression mechanism 200 may be press-fitted into the center of the rotor 420.

The compression mechanism 200 may include a fixed scroll 210 which is fixedly installed, and an orbiting scroll 220 engaged with the fixed scroll 210, forming a compression chamber together with the fixed scroll 210 and orbited by the rotary shaft 300.

In the exemplary embodiment, the compression mechanism 200 is formed to be a scroll type, but is not limited thereto, and the compression mechanism 200 may be formed to be various types, for example, a reciprocating type, and a vane rotary type, etc.

The inverter 500 may include a printed circuit board 510 on which various elements such as the switching element are installed, and a plurality of pin holes 512 into which a plurality of pins 620, which will be described below, is inserted, and through the plurality of pin holes 512, the printed circuit board 510 may be electrically connected to the connector 600.

The connector 600 may include a plate 610 covering the through hole 122a of the partition wall 122 and supporting the plurality of pins 620 while sealing the motor accommodating space against the inverter accommodating space, the plurality of pins 620 formed of an electrically conductive material, passing through the plate 610, and inserted into the motor terminal 412 and the pin hole 512 of the printed circuit board 510 to be electrically connected therebetween, and an insulator 630 insulating the plurality of pins 620 from the plate 610.

In this case, as illustrated in FIGS. 3 and 4, the switching element may be formed to be an intelligent power module 520 in which an own protection function or a driving circuit of a power apparatus such as a metal-oxide-semiconductor field-effect transistor (MOSFET) or an IGBT is added.

In addition, the IPM 520 includes a plurality of motor connecting terminals 522, which are connected to the plurality of pine holes 512, respectively, and the IPM 520 may be disposed such that the plurality of motor connecting terminals 522 is disposed toward the plurality of pin holes 512, and that an arrangement direction of the plurality of motor connecting terminals 522 disposed in one line along a longitudinal direction of the IPM 520 is disposed parallel to an arrangement direction of the plurality of pin holes 512 disposed in one line along a longitudinal direction of the plate 610.

Further, the IPM 520 may be disposed such that a spacing distance between the plurality of motor connecting terminals 522 and the plurality of pin holes 512 is equal to or greater than 4 mm and equal to and smaller than 20 mm.

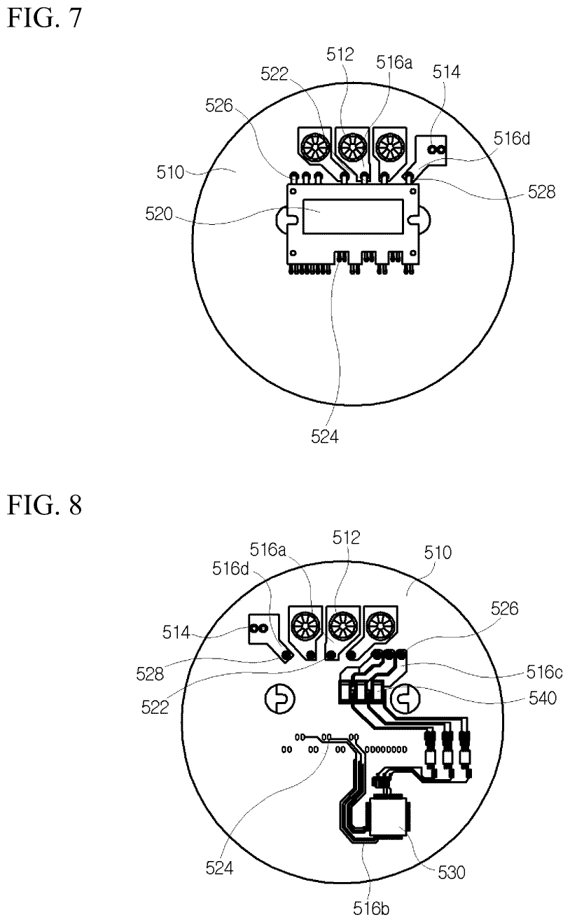

Moreover, the plurality of motor connecting terminals 522 of the IPM 520 may be electrically connected to the plurality of pin holes 512 by a motor connecting pattern (refer to 516a in FIG. 7) printed on the printed circuit board 510.

Hereinafter, an operational effect of the electric compressor according to the present disclosure will be described.

That is, in the electric compressor of the present disclosure, when power is applied to the motor 400, a low-temperature and low-pressure refrigerant is introduced into the motor accommodating space through the suction port (not illustrated), and the refrigerant in the motor accommodating space is introduced into the compression mechanism 200, is compressed to have a high temperature and a high pressure, and is discharged to the outside the housing 100 after passing through the discharge chamber.

During the above process, the motor 400 is controlled by the inverter 500 which is electrically connected through the connector 600, thereby the cooling efficiency can be variably controlled.

Here, in the electric compressor according to the present disclosure, a space occupied by the switching element in the printed circuit board 510 may be reduced because the switching element is formed to be the IPM 520. By doing so, a degree of freedom in designing elements other than the switching element may increase and a size of the printed circuit board 510 may decrease.

Further, the IPM 520 is disposed such that the plurality of motor connecting terminals 522 is disposed toward the plurality of pin holes 512, therefore, a connection distance between the plurality of pin holes 512 and the plurality of motor connecting terminals 522 can be reduced. In particular, the IPM 520 is disposed such that an arrangement direction of the plurality of motor connecting terminals 522 is parallel to an arrangement direction of the plurality of pin holes 512, therefore, a connection distance between the plurality of pin holes 512 and the plurality of motor connecting terminals 522 is further reduced, and the arrangement position of the both may become similar to each other. Because of this, a wiring structure connecting the plurality of pin holes 512 and the plurality of motor connecting terminals 522 to each other is simplified and the possibility of dielectric breakdown is lowered, and an additional member such as a bus bar for electrically connecting two components to each other whiles tidying up wires and preventing dielectric breakdown may be omitted. Therefore, the quantity of parts, the cost, and the weight can be reduced.

Further, because the IPM 520 is disposed such that the spacing distance between the plurality of motor connecting terminals 522 and the plurality of pin holes 512 is equal to or greater than 4 mm and equal to and smaller than 20 mm, the connection distance between the plurality of motor connecting terminals 522 and the plurality of pin holes 512 can be reduced within a range in which the dielectric breakdown is prevented. That is, because the minimum spacing distance (the smallest value among the spacing distances) between the plurality of motor connecting terminals 522 and the plurality of pin holes 512 is secured to be 4 mm or more, the dielectric breakdown between the plurality of motor connecting terminals 522 and the plurality of pin holes 512 can be constrained, and because the maximum spacing distance (the greatest value among the spacing distances) between the plurality of motor connecting terminals 522 and the plurality of pin holes 512 is limited to be 20 mm or less, the dielectric breakdown between the wiring connecting the plurality of motor connecting terminals 522 and the plurality of pin holes 512 to each other and another component can be constrained.

Here, the present embodiment assumes the case where a voltage applied to the inverter 500 is 800V or more, however, in a case where the voltage applied to the inverter 500 is less than 800V, the IPM may be disposed such that the minimum spacing distance between the plurality of motor connecting terminals 522 and the plurality of pin holes 512 is more than 0 mm and smaller than 4 mm. In this case, the connection distance between the plurality of motor connecting terminals 522 and the plurality of pin holes 512 may be further reduced within a range in which the dielectric breakdown is prevented.

In addition, as the plurality of motor connecting terminals 522 and the plurality of pin holes 512 are connected by the motor connecting pattern (refer to 516a in FIG. 7) printed on the printed circuit board 510, the possibility of dielectric breakdown, the quantity of parts, the cost, and the weight can be further reduced.

Meanwhile, in the present embodiment, the plurality of motor connecting terminals 522 and the plurality of pin holes 512 are formed in three each, and the plurality of pin holes 512 includes a first pin hole 512a, a second pin hole 512b adjacent to the first pin hole 512a, and a third pin hole 512c formed on an opposite side of the first pin hole 512a based on the second pin hole 512b, and the plurality of motor connecting terminals 522 includes a first motor connecting terminal 522a connected to the first pin hole 512a, a second motor connecting terminal 522b adjacent to the first motor connecting terminal 522a and connected to the second pin hole 512b, and a third motor connecting terminal 522c formed on an opposite side of the first motor connecting terminal 522a based on the second motor connecting terminal 522b and connected to the third pin hole 512c. Further, a spacing distance between the first motor connecting terminal 522a and the second motor connecting terminal 522b is smaller than a spacing distance between the first pin hole 512a and the second pin hole 512b, and a spacing distance between the second motor connecting terminal 522b and the third motor connecting terminal 522c is smaller than a spacing distance between the second pin hole 512b and the third pin hole 512c, therefore, all the first to third motor connecting terminals 522c cannot be disposed to be opposed to all the first to third pin holes 512c in a direction perpendicular to the arrangement direction of the plurality of pin holes 512. Accordingly, a connection distance between the first motor connecting terminal 522a and the first pin hole 512a, a connection distance between the second motor connecting terminal 522b and the second pin hole 512b, and a connection distance between the third connecting terminal 522c and the third pin hole 512c cannot be the same and at the same time, cannot be the minimum. However, as the second motor connecting terminal 522b is disposed to be opposed to the second pin hole 512b in the direction perpendicular to the arrangement direction of the plurality of pin holes 512, the connection distance between the plurality of motor connecting terminals 522 and the plurality of pin holes 512 can be optimized within a given condition. That is, a spacing distance between the second motor connecting terminal 522b and the second pin hole 512b becomes a minimum distance, and each of a spacing distance between the first motor connecting terminal 522a and the first pin hole 512a, and a spacing distance between the third connecting terminal 522c and the third pin hole 512c increases a little bit more than the spacing distance between the second motor connecting terminal 522b and the second pin hole 512b, however, the spacing distance between the first motor connecting terminal 522a and the first pin hole 512a, and the spacing distance between the third connecting terminal 522c and the third pin hole 512c may become equal to each other. Therefore, compared to the spacing distance between the second motor connecting terminal 522b and the second pin hole 512b, an increase in the spacing distance between the first motor connecting terminal 522a and the first pin hole 512a, and an increase in the spacing distance between the third connecting terminal 522c and the third pin hole 512c can be minimized.

Meanwhile, in the present embodiment, the plurality of motor connecting terminals 522 and the plurality of pin holes 512 are disposed in a width direction of the printed circuit board 510 (a left-right direction in FIG. 3), but are not limited thereto.

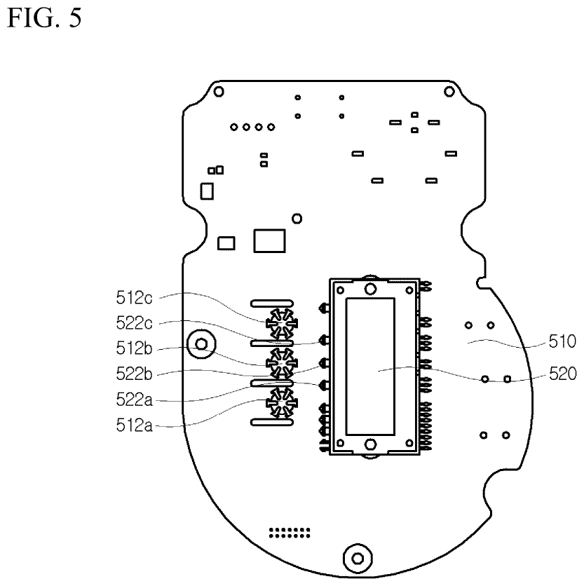

That is, as illustrated in FIG. 5, the plurality of pin holes 512 may be disposed in a longitudinal direction (a vertical direction in FIG. 5) of the printed circuit board 510, and the plurality of motor connecting terminals 522 may be disposed in a direction parallel to the arrangement direction of the plurality of pin holes 512. In this case, the operational effect described above may be obtained because the plurality of motor connecting terminals 522 and the plurality of pin holes 512 are disposed to be parallel to each other and are opposed to each other.

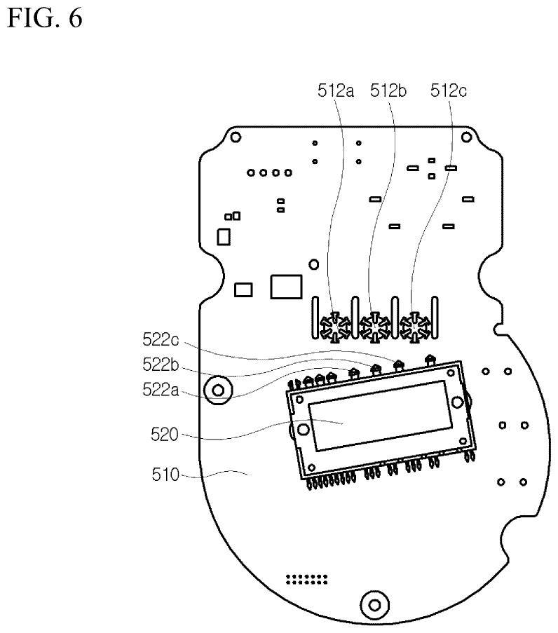

Alternatively, for example, when it is impossible to dispose the plurality of motor connecting terminals 522 along a direction parallel to the arrangement direction of the plurality of pin holes 512 because of another component, the IPM 520 may be tilted as illustrated in FIG. 6. However, an angle of the tilting needs to be limited so that the above-described operational effect can be achieved in this case as well. That is, the IPM 520 needs to be disposed such that the plurality of motor connecting terminals 522 is disposed along a direction forming an angle of more than 0 degree and equal to or smaller than 15 degrees with a direction parallel to the arrangement direction of the plurality of pin holes 512, so that a connection distance between a certain motor connecting terminal (522a in case of FIG. 6) and a pin hole corresponding to the certain motor connecting terminal does not increase overly while the plurality of motor connecting terminals 522 is headed to the plurality of pin holes 512 even if the IPM 520 is tilted. At this instance, the angle is measured to be an acute angle between an axis parallel to the arrangement direction of the plurality of pin holes 512 and an axis of the arrangement direction of the plurality of motor connecting terminals 522 rotated in a clockwise direction or an anti-clockwise direction.

Meanwhile, like the present embodiment, as the plurality of motor connecting terminals 522 of the IPM 520 is disposed to be headed to the plurality of pin holes 512 of the printed circuit board 510, a flow of a signal can be restrained from being interrupted by the noise.

In more detail, an inductance, which is a parasitic component generating the noise, exists in a pattern (a wire) in which the signal flows. In addition, when the pattern exists in plural number, a crosstalk, from which a signal and the noise is dispersed between a plurality of patterns, is generated. The inductance and the crosstalk interrupt a flow of a signal flowing through the pattern, and the longer a length of the pattern, the more the amount of crosstalk increases in the pattern, and the crosstalk due to an overlap with another pattern increases, thereby the signal may not flow smoothly.

However, as in the present disclosure, because the IPM 520 is disposed such that the plurality of motor connecting terminals 522 is disposed to be headed to the plurality of pin holes 512 of the printed circuit board 510, a length of the motor connecting pattern 516a can be reduced. Accordingly, the inductance in the motor connecting pattern 516a is reduced, and thus, the noise generation in the motor connecting pattern 516a can be reduced.

In addition, as the length of the motor connecting pattern 516a is reduced, a possibility of the motor connecting pattern 516a to overlap another pattern is reduced, therefore, a crosstalk between the motor connecting pattern 516a and another pattern can be reduced.

In more detail, referring to FIGS. 7 and 8, the printed circuit board 510 may include various patterns other than the motor connecting pattern 516a.

That is, the inverter 500 may further include a processor 530 mounted on the printed circuit board 510, the IPM 520 may further include a pulse width modulation (PWM) terminal 524 electrically connected to the processor 530, and the printed circuit board 510 may further include a pulse width modulation pattern 516b electrically connecting the pulse width modulation terminal 524 and the processor 530.

Moreover, the inverter 500 may further include a shunt resistance 540 mounted on the printed circuit board 510, the IPM 520 may further include a sensing terminal 526 electrically connected to the shunt resistance 540, and the printed circuit board 510 may further include a sensing pattern 516c electrically connecting the shunt resistance 540 to the sensing terminal 426 and the processor 530.

In addition, the IPM 520 may further include a power terminal 528, and the printed circuit board 510 may further include a high voltage input unit 514 to which a high voltage is applied, and a high voltage pattern 516d electrically connecting the high voltage input unit 514 to the power terminal 528.

Here, as the plurality of motor connecting terminals 522 of the IPM 520 is disposed to be headed to the plurality of the pin holes 512 of the printed circuit board, the length of the motor connecting pattern 516a is reduced, and therefore, the possibility of the motor connecting pattern 516a to overlap the pulse width modulation pattern 516b, the sensing pattern 516c, and the high voltage pattern 516d can be reduced. Because of this, a crosstalk between at least one among the pulse width modulation pattern 516b, the sensing pattern 516c, and the high voltage pattern 516d, and the motor connecting pattern 516a can be reduced.

Further, as the plurality of motor connecting terminals 522 of the IPM 520 is disposed to be headed to the plurality of pin holes 512 of the printed circuit board 510, the processor 530, the pulse width modulation terminal 524, and the pulse width modulation pattern 516b may be disposed on an opposite side of the motor connecting pattern 516a based on the IPM 520. Because of this, the possibility of the motor connecting pattern 516a to overlap the pulse width modulation pattern 516b is further reduced, and therefore, a crosstalk between the motor connecting pattern 516a and the pulse width modulation pattern 516b can be further reduced. Moreover, a length of the pulse width modulation pattern 516b can be reduced. Accordingly, a possibility of the pulse width modulation pattern 516b to overlap another pattern (e.g., the sensing pattern 516c, the high voltage pattern 516d) as well as the motor connecting pattern 516a, and a crosstalk occurring due to such overlap can be reduced. Further, an inductance within the pulse width modulation pattern 516b and the noise generation because of the inductance can be reduced.

In addition, as the plurality of motor connecting terminals 522 of the IPM 520 is disposed to be headed to the plurality of pin holes 512 of the printed circuit board 510, the sensing terminal 526 is spaced apart from the plurality of motor connecting terminals 522 on an axis of the arrangement direction of the plurality of motor connecting terminals 522, and the shunt resistance 540, the processor 530, and the sensing pattern 516c may be disposed on an opposite side of the motor connecting pattern 516a based on an axis of the arrangement direction of the plurality of motor connecting terminals 522. Because of this, the possibility of the motor connecting pattern 516a to overlap the sensing pattern 516c is further reduced, and the crosstalk between the motor connecting pattern 516a and the sensing pattern 516c can be further reduced. In addition, a length of the sensing pattern 516c can be reduced. Accordingly, the possibility of the sensing pattern 516c to overlap another pattern (e.g., the pulse width modulation pattern 516b, the high voltage pattern 516d) as well as the motor connecting pattern 516a and the crosstalk occurring due to such overlap can be reduced. Moreover, an inductance in the sensing pattern 516c is reduced, and thus, the noise generation because of the inductance can be reduced.

In addition, as the plurality of motor connecting terminals 522 of the IPM 520 is disposed to be headed to the plurality of pin holes 512 of the printed circuit board 510, the high voltage input unit 514 may be disposed on a side of the plurality of pin holes 512, the power terminal 528 may be disposed on the high voltage input unit 514 side based on the plurality of motor connecting terminals 522, and the high voltage pattern 516d may be disposed on the high voltage input unit 514, and the power terminal 528 side based on the motor connecting pattern 516a.

Here, the power terminal 528 may be disposed on an opposite side of the sensing terminal 526 on an axis of the arrangement direction of the plurality of motor connecting terminals 522 based on the plurality of motor connecting terminals 522, and the high voltage input unit 514 and the high voltage pattern 516d may be disposed on an opposite side of the sensing pattern 516c based on the power terminal 528. Because of this, a possibility of the motor connecting pattern 516a to overlap the high voltage pattern 516d is further reduced, and a crosstalk between the motor connecting pattern 516a and the high voltage pattern 516d can be further reduced. Further, a length of the high voltage pattern 516d can be reduced. Therefore, a possibility of the high voltage pattern 516d to overlap another pattern (e.g., the pulse width modulation pattern 516b, the sensing pattern 516c) as well as the motor connecting pattern 516a and the crosstalk because of the overlap can be reduced. In particular, as the high voltage pattern 516d and the sensing pattern 516c are disposed on opposite sides to each other, the crosstalk between the high voltage pattern 516d and the sensing pattern 516c can be dramatically reduced. In addition, an inductance in the high voltage pattern 516d and the noise generation because of the inductance can be reduced.

1-14. (canceled)

15. An electric compressor comprising:
a motor configured to generate power;
a compression mechanism driven by the motor and configured to compress a refrigerant;
an inverter configured to control the motor; and
a plurality of pins configured to electrically connect the motor and the inverter, wherein the inverter includes a printed circuit board (PCB) on which a switching element is mounted, wherein the printed circuit board (PCB) includes a plurality of pin holes into which the plurality of pins is inserted, wherein the switching element is formed to be an intelligent power module (IPM) having a plurality of motor connecting terminals, which are connected to the plurality of pin holes, respectively, and wherein the IPM is disposed such that the plurality of motor connecting terminals is disposed toward the plurality of pin holes.

16. The electric compressor of claim 15, wherein the IPM is disposed such that the plurality of motor connecting terminals is disposed along a direction parallel to a direction in which the plurality of pin holes is disposed.

17. The electric compressor of claim 15, wherein the IPM is disposed such that the plurality of motor connecting terminals is disposed along a direction forming an angle equal to or smaller than 15 degrees with a direction parallel to a direction in which the plurality of pin holes is disposed.

18. The electric compressor of claim 15, wherein the IPM is disposed such that at least one among the plurality of motor connecting terminals is disposed to be opposed to one of the plurality of pin holes in a direction perpendicular to a direction in which the plurality of pin holes is disposed.

19. The electric compressor of claim 15, wherein the IPM is disposed such that a maximum spacing distance between the plurality of motor connecting terminals and the plurality of pin holes is equal to or smaller than 20 mm.

20. The electric compressor of claim 19, wherein when a voltage applied to the inverter is 800V or more, the IPM is disposed such that a minimum spacing distance between the plurality of motor connecting terminals and the plurality of pin holes is equal to or more than 4 mm.

21. The electric compressor of claim 19, wherein when a voltage applied to the inverter is less than 800V, the IPM is disposed such that a minimum spacing distance between the plurality of motor connecting terminals and the plurality of pin holes is more than 0 mm and smaller than 4 mm.

22. The electric compressor of claim 15, wherein the PCB further includes a motor connecting pattern electrically connecting the plurality of pin holes and the plurality of motor connecting terminals.

23. The electric compressor of claim 22, wherein the inverter further includes a processor mounted on the PCB, wherein the IPM further includes a pulse width modulation (PWM) terminal electrically connected to the processor, wherein the PCB further includes a pulse width modulation pattern electrically connecting the pulse width modulation terminal and the processor, and wherein the processor, the pulse width modulation terminal, and the pulse width modulation pattern are disposed on an opposite side of the motor connecting pattern based on the IPM.

24. The electric compressor of claim 23, wherein the inverter further includes a shunt resistance mounted on the PCB, wherein the IPM further includes a sensing terminal electrically connected to the shunt resistance, wherein the PCB further includes a sensing pattern electrically connecting the shunt resistance to the sensing terminal and the processor, and wherein the sensing terminal is disposed to be spaced apart from the plurality of motor connecting terminals on an axis of a direction in which the plurality of motor connecting terminals is disposed, and the shunt resistance, the processor, and the sensing pattern are disposed on an opposite side of the motor connecting pattern based on the axis.

25. The electric compressor of claim 24, wherein the IPM further includes a power terminal, wherein the PCB further includes a high voltage input unit to which a high voltage is applied and a high voltage pattern configured to electrically connect the high voltage input unit to the power terminal, and wherein on the axis, the power terminal is disposed on an opposite side of the sensing terminal based on the plurality of motor connecting terminals, and the high voltage input unit and the high voltage pattern are disposed on an opposite side of the sensing pattern based on the power terminal.

26. The electric compressor of claim 25, wherein the motor connecting pattern, the pulse width modulation pattern, the sensing pattern, and the high voltage pattern do not intersect each other.

27. The electric compressor of claim 15, wherein the IPM includes a power terminal, wherein the PCB further includes a high voltage input unit to which a high voltage is applied and a high voltage pattern configured to electrically connect the high voltage input unit to the power terminal, and wherein the high voltage input unit is disposed on a side of the plurality of pin holes, the power terminal is disposed on a side of the high voltage input unit based on the plurality of motor connecting terminals, and the high voltage pattern is disposed on the high voltage input unit and a side of the power terminal based on a motor connecting pattern.

28. An electric compressor comprising:
a motor configured to generate power;
a compression mechanism driven by the motor and configured to compress a refrigerant;
an inverter configured to control the motor; and
a plurality of pins configured to electrically connect the motor and the inverter, wherein the inverter includes a printed circuit board (PCB) on which a switching element is mounted, wherein the switching element is formed to be an intelligent power module (IPM) having a plurality of motor connecting terminals, and wherein the PCB includes a plurality of pin holes into which the plurality of pins is inserted, and a motor connecting pattern electrically connecting the plurality of pin holes and the plurality of motor connecting terminals.
